(19) United States
(12) Patent Application Publication
(10) Pub. No.: US 2025/0314326 A1
(43) Pub. Date: Oct. 9, 2025

(54) PRESSURE REGULATOR ACTUABLE BY INCONGRUENT ANGULAR DEFLECTION OF THE INLET VALVE STEM

(71) Applicants: Anthony Hollars, Tucson, AZ (US); Li-Wei Chen, Su'ao Township (TW)

(72) Inventors: Anthony Hollars, Tucson, AZ (US); Li-Wei Chen, Su'ao Township (TW)

(21) Appl. No.: 18/964,592

(22) Filed: Dec. 1, 2024

Related U.S. Application Data
(60) Provisional application No. 63/605,167, filed on Dec. 1, 2023.

(51) Int. Cl. F16K 31/52; F16K 1/36

(52) U.S. Cl. CPC F16K 31/52; F16K 1/36

(57) ABSTRACT

A pressure regulator designed to reduce high incoming vapor pressure to a lower, outlet vapor pressure.

### FIELD OF THE INVENTION

This invention relates to a piston-type or diaphragm type fluid pressure regulator featuring a novel fluid inlet valve, capable of regulating inlet pressures ranging from low to high. More particularly, the present invention is capable of regulating pressurized gases, high pressure down to a workable, substantially constant outlet pressure. Fewer components over the prior-art are one design emphasis thus making a simplistic and reliable regulator that is both easy and relatively inexpensive to manufacture.

### BACKGROUND OF THE INVENTION

Pressure regulators have existed for many years and the field is crowded with different designs. Yet, innovative features are still being introduced into pressure regulators such as safety features, compatibility with different fluids, construction materials and others.

Two major species of mechanical fluid pressure regulators are common: piston-type and diaphragm-type. In general, however, these have not proven entirely satisfactory in practice.

A piston-type regulator uses a spring-biased piston in a bore to regulate output pressure with the piston always trying to reside in equilibrium. When not in equilibrium, the piston moves up or down in the bore thus opening or shutting an intake valve from a high-pressure source. One side of the piston is biased by a spring force and the other side of the piston is biased by pressurized gas.

A diaphragm-type regulator works in a very similar way. Rather than moving a piston in a bore, a diaphragm acts as a flexure, biased on one side typically by a spring. The other side of the diaphragm contains the regulated pressure. When the biasing forces on each side are not in equilibrium, the diaphragm flexes thus opening or closing an inlet valve from the high-pressure source.

Regulators that are designed to handle high source pressures, whether they be of the piston-type or diaphragm-type typically use a hard valve and seat as the major components of the inlet valve assembly. The design of a hard valve and seat works well until the smallest bit of contamination, corrosion, or surface imperfection or seal ‘set’ is introduced into the valve assembly. The result is a faulty regulator that will not predictably produce a substantially constant outlet pressure.

Likewise, a piston-type or diaphragm-type regulator designed to regulate lower source pressures typically uses a soft elastomeric seal in the valve assembly to hold back the source pressure. This art is less prone to failure due to contamination, corrosion, or surface imperfections compared to the hard valve and seat because the elastomeric seal conforms to minor valve imperfections. Unfortunately, an elastomeric seal is not capable of retaining high source pressures because the high pressures may cause permanent deformation and/or swelling. In addition, explosive decompression results when the high-pressure source is suddenly removed from an elastomeric seal sometimes causing a permanently defective seal.

Regulators typically cannot regulate a high-pressure gas down to a low pressure, (sub 10 percent of the initial inlet pressure, because the force to open the inlet vale stem becomes higher as the inlet pressure increases. The force and related friction required to open the inlet valve stem becomes too great to allow a consistent regulation because the opening force and friction become a large variable in the reaction of the regulating piston, causing inconsistent regulation. This leads to the need for a first stage to coarsely regulate to a workable lower pressure and then a second stage to regulate consistently at a low pressure.

U.S. Pat. No. 6,843,388, titled Compressed Gas Cartridge Dispensing System Allowing Interchangeable Use Of Different Capacity Compressed Gas Cartridges And Novel Storage Feature, filed Jul. 22, 2002 by Hollars (same inventor) extensively elaborates on methods of harnessing threaded and non-threaded compressed gas cartridges. The same referenced application also discusses many of the available capacities and dimensions of compressed gas cartridges commonly available.

The most similar prior-art pressure regulation device located in a prior-art search that even remotely resembles the present invention utilizes an equal or greater number of components. U.S. Pat. No. 5,628,350 by Gibb titled Inflating device that comprises, at minimum, thirteen components to achieve similar results. Yet, Gibb's patent offers no pressure relief features that prevent the regulated fluid pressure from becoming excessive as will be elaborated in the following embodiments.

### SUMMARY OF THE INVENTION

This pressure regulator is specifically designed to reduce high vapor pressure down to a substantially a consistent, lower, outlet pressure. Due to the nature of the crowded regulator art, the soon to be embodied pressure regulator has been specifically embodied for use in the harnessing art and this specific use is carried into the claims. Exemplified in the pressure regulator embodiments is a reduced amount of components over existing designs. Additionally, safety and reliability features have been integrated into the design and will shortly be taught in the following paragraphs. A burp-off feature in all embodiments will be exemplified that vents back-pressure spikes as well as a method of adjusting the burp-off back-pressure spikes independent of regulated pressure in some embodiments.

The present invention has solved the problems cited above. Broadly, this is a regulator design comprising rather typical regulator architecture but with a unique hybrid valve design that has the advantages of both hard seat and soft elastomeric seal. This valve is designed to be sealed by an elastomeric seal while being supported on a rigid seat.

Additionally, and most importantly this novel inlet vale stem arrangement uses an acute angle on the inlet vale stem and or the piston or diaphragm actuating element to allow a very low force actuation of the inlet stem solving the long-standing issues in prior art regulators of inconsistent regulation due to friction and high operating force of the inlet valve.

The benefits in this design allow source pressures to be rather low or extremely high. Typically, the flow-obstructing component of this assembly is a rigid ball or substantially circular disk. The rigid seat allows only the obstructing component of the valve to compress the elastomeric seal a pre-determined amount. Any additional forces on the valve obstructing part, such as from a high source pressure, transfer to the rigid valve seat, thus not further compressing the elastomeric seal and damaging it.

This hybrid valve assembly allows increased versatility over previous designs and has proven to work well in a pressure regulator. One major benefit is that the source pressure can start out high such as occurs when harnessing a compressed gas cartridge, or when a harnessed compressed gas cartridge is subjected to heat where only the traditioflal hard valve and seat design would reliably retain such source pressures. At a later time, such as when some of the fluid in a compressed gas cartridge has been consumed, the source pressure is lower. A traditional elastomeric sealed inlet valve would appropriately retain the lower pressure but would not have worked when the source pressure was higher. Therefore, a need exists for a valve that can handle extremely high inlet pressures and reliably work as the inlet pressure considerably decreases. In practice, this scenario is typical when harnessing a compressed gas cartridge and desiring a substantially constant outlet pressure regardless of cartridge (source) pressure.

Additionally, because the rigid valve seat is supporting the flow-obstructing component of the valve, the elastomeric seal is prevented from taking a compression-set and works well as valve assembly temperature varies. This is also resistant to contamination or corrosion allowing long-term reliable containment of high or low pressures providing advantages of both valve prior-art designs without the disadvantages of either.

The main regulator body is preferably molded from a fiber-reinforced plastic therefore features can easily be reproduced on each unit once the initial molds are built.

A safety feature that particularly is preferred is negative vents that allow fluid to escape the regulator should the pressure contained by the piston and biased by the regulator main spring become excessive. It is an object of the invention to provide adequate system adjustability so that the regulator can burp off excessive back-pressure.

This regulator is intended to be manufactured from as few components as possible.

The regulator is intended to be manufactured utilizing as many parts as possible out of a plastic material.

The intention of this design is simplicity through fewer parts with perhaps lower manufacturing cost than any existing regulator available today. Additionally, high reliability should be realized from the repeatability standpoint of plastic molded parts Once the design is proven, each duplicate part should be substantially equal.

### BRIEF DESCRIPTION OF THE DRAWINGS

The invention will be better understood from a reading of the following detailed description taken in conjunction with the drawings in which like reference designators are used to designate like elements, and in which FIGS. 1, 2, 3, 4, 5. and 6, each illustrates a different embodiment of Applicants' valve assembly, and wherein the large arrow in each Figure represents an incoming fluid stream, that fluid comprising one or more gases, one or more liquids, and combinations thereof.

FIG. 1 illustrates an aligned valve assembly.

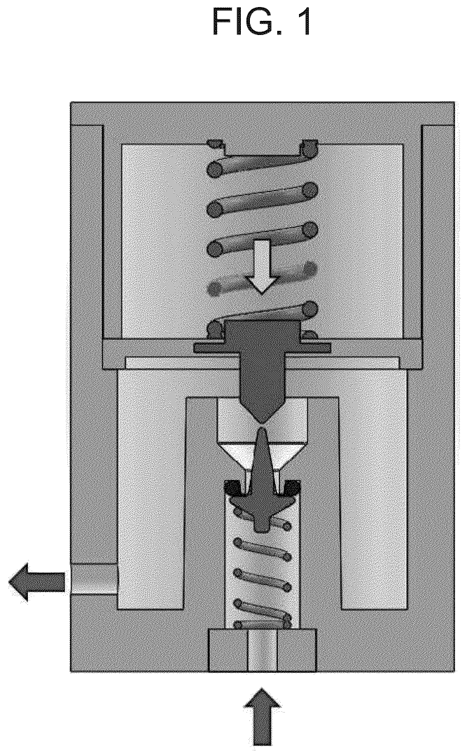

FIG. 2 illustrates an offset valve assembly.

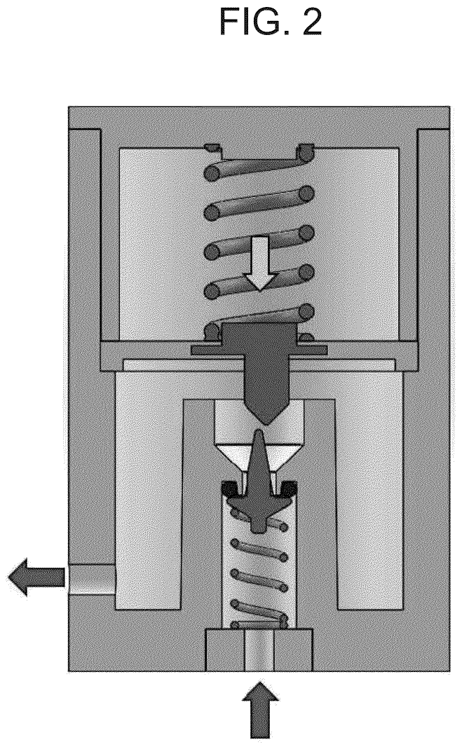

FIG. 3 illustrates a not actuated valve assembly.

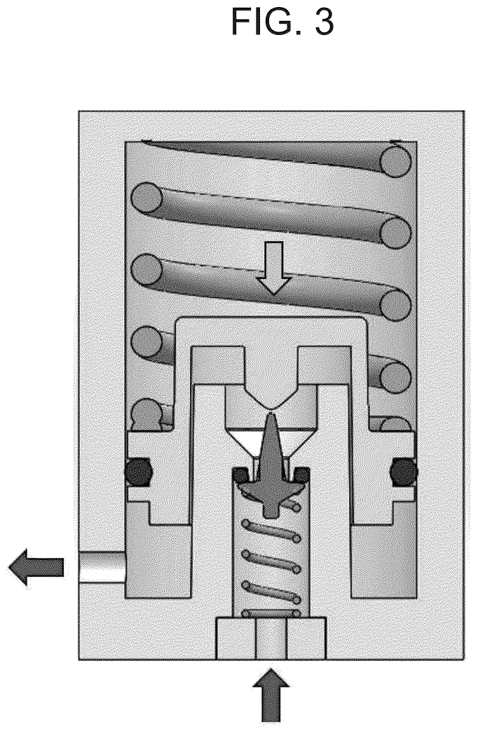

FIG. 4 illustrates an actuated valve assembly.

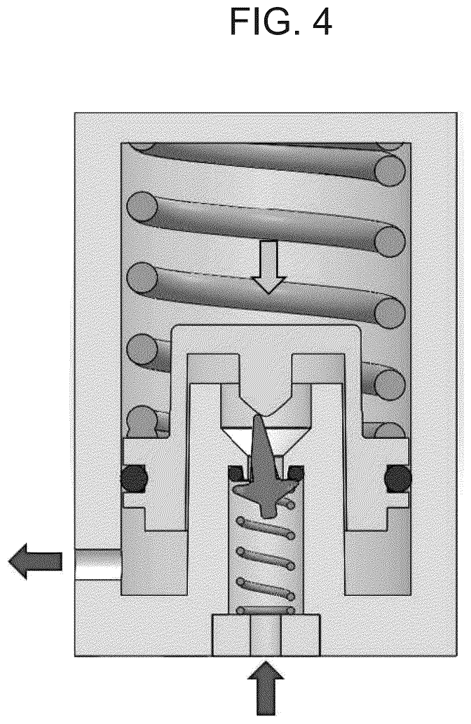

FIG. 5 illustrates the offset actuator resting on a valve assembly.

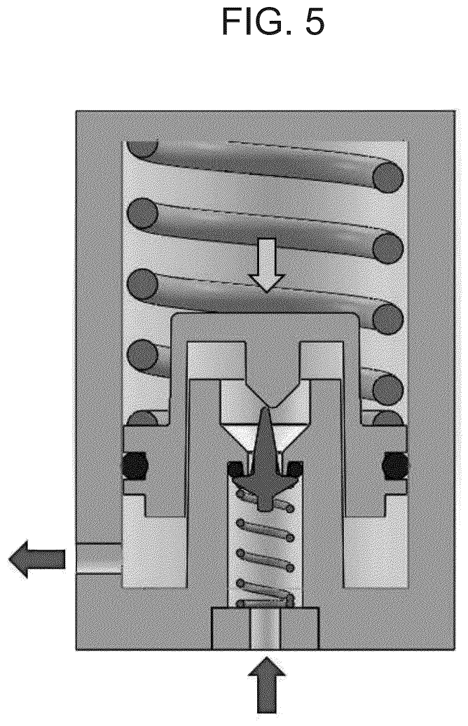

FIG. 6 illustrates the offset actuated on a valve assembly.

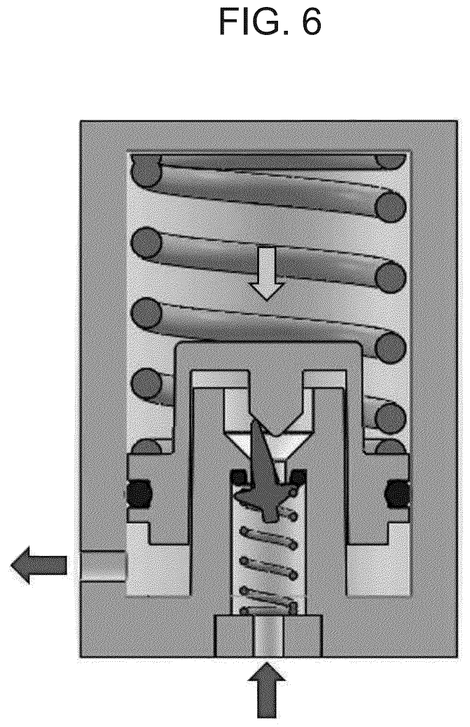

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention, and it will be appreciated by those skilled in the art that it is intended to cover alternatives, modifications, and equivalents as may be included within the spirit and scope of the invention as defined by the appended claims and their equivalents as supported by the following disclosure and drawings.

The lower inlet valve operation operating force of this regulator allows for much improved accuracy and repeatability and the elimination of the need for a two-stage regulator especially for lower pressure operation with high input pressures. Any prior art regulator inlet valve when actuated requires a force that in increases greatly as the inlet pressure increases relative to the effective surface area of the valve. High pressure fluid sources cause the opening force to be high enough to have an effect of the regulators ability to function accurate. It follows that the lower the actuation force required to open the Inlet valve the more accurate the regulator can be reduced.

This regulator uses a design whereby the Inlet valve blocking stem is able to be opened very easily because it is not contained axially but allowed to move in any direction upstream or transversely but the actuating stem is contained axially and can only move on its axis. This unique design is able to force multiply the movement of the pressure sensing piston or diaphragm depending on which is being used, because the angle of the inlet blocking stem and or the actuating stem can be very acute allowing for force multiplication. The angles can be split between the two stems or applied to just one of the two. The actuating stem can align axially with the inlet valve or offset if desired for even more force multiplication. This arrangement allows for such a low valve opening force that the regulator can be much more accurate that prior art regulators. No matter if one stem or both contains an angle and no matter the number of degrees that angle is manufactured to, the slightest axial movement of the actuating stem relative to blocking stem creates a leveraged deflecting force because of the incongruence between them resulting in opening the inlet valve. Regardless of the angles on each stem, even if they are matching angles, they cannot occupy the same space when the actuating stem moves toward the non-axially contained blocking stem they are incongruent and a deflection of the blocking stem occurs opening the inlet valve. The operation of this valve design differs greatly from the needle valve, ball valve, rocker valve, or other valves commonly used in the inlet of regulators.

We claim:

1. A fluid regulator, comprising an Inlet valve blocking stem having movement that is not contained axially.

2. The fluid regulator of claim 1, wherein said Inlet blocking stem moves in any direction upstream or transversely.

3. The fluid regulator of claim 2, further comprising an Actuating Stem comprising an axis and attached to a distal end of said Inlet valve blocking stem, wherein said Actuating stem is contained axially and can only move on its axis.
